(19) United States
(12) Patent Application Publication
(10) Pub. No.: US 2023/0058901 A1
(43) Pub. Date: Feb. 23, 2023

(54) METHOD FOR RECOVERING THE SYMBOL TIME BY A RECEIVING DEVICE

(71) Applicant: SIGFOX, LABEGE (FR)

(72) Inventors: Stéphane BAILLS, TOULOUSE (FR); Maxime BESSET, TOULOUSE (FR); Zirphile LIONEL, RAMONVILLE SAINT AGNE (FR)

(21) Appl. No.: 17/796,861

(22) PCT Filed: Feb. 4, 2021
(86) PCT No.: PCT/EP2021/052660

§ 371 Date: Aug. 1, 2022

(30) Foreign Application Priority Data
Feb. 6, 2020 (FR) FR2001190

(51) Int. Cl. H04L 7/033; H04L 7/00

(52) U.S. Cl. CPC H04L 7/033; H04L 7/0087

(57) ABSTRACT

A method for recovering the symbol time by a receiver to decode a sequence of symbols transmitted by a transmitter when the symbol time of the transmitter is biased with respect to the symbol time of the receiver. When a transition is detected between two consecutive symbols, an absolute error on the instant of the current symbol is measured and a statistical model of the bias is updated. A correction may then be applied to the instants of the subsequent symbols depending on the measured absolute error and/or a bias estimated from the statistical model. During periods in which there are no transitions between symbols, an absolute error cannot be measured, but it is still possible to apply a correction to the instants of the subsequent symbols depending on a relative error extrapolated from the statistical model.

### FIELD OF INVENTION

The present invention belongs to the field of digital communications. More particularly, the invention relates to a method for recovering the symbol time by a receiving device in order to decode a sequence of symbols transmitted by a transmitting device in a case where the symbol time of the transmitting device can be modeled by a stationary process having a non-negligible bias relative to the symbol time of the receiving device.

### STATE OF THE ART

In digital communications systems, when a transmitter transmits a message in the form of a sequence of symbols, a coherent receiver must know the synchronization of the symbols transmitted by the transmitter to be able to decode the message.

The symbol time at the transmitting device is determined from a clock belonging to the transmitting device. The symbol time at the receiving device is determined from a clock belonging to the receiving device. However, a bias may exist between the clock of the transmitting device and the clock of the receiving device if the two clocks have a non-negligible frequency difference relative to each other. Such a situation leads to a drift of the symbol time of the receiving device relative to the symbol time of the transmitting device, which leads to an increasing error in the determination of the instants of the symbols during sampling by the receiving device. This can lead to errors in symbol decoding and potentially to an inability to decode the received message.

There are different methods for recovering the symbol time allowing estimating the ideal sampling point of a symbol. The methods for tracking the synchronization of the digital signals are generally based on continuous measurement and correction steps. Each method includes specific constraints on the channel coding, the modulation pulse shaping, the symbol generation, the signal sampling, etc. For example, a method based on the Gardner algorithm allows measuring and correcting an error on the symbol time at each transition between two successive symbols.

However, the existing methods are not always sufficiently effective when the bias between the symbol time of the transmitting device and the symbol time of the receiving device is significant, in particular in the case where the used modulation does not necessarily cause a state transition between two successive symbols. It is certainly possible to use modulation pulses whose shape contains a state transition at each symbol, such as for example the return-to-zero (RZ) coding. With such a coding, the signal has a state transition at each symbol, even if there is a succession of two identical symbols. However, the return-to-zero coding consumes twice the bandwidth to achieve the same throughput compared to the non-return-to-zero (NRZ) format.

In the wireless communication systems of the Internet of Things (IoT) type, the transmitting devices are generally low-cost devices for which the technical specifications on the symbol transmission frequency (“baud rate”) should not be too restrictive. It is necessary to find for such a system a solution allowing effectively synchronizing the symbol time at a receiving device, in particular when the used modulation does not favor the transitions between symbols.

### Object and Summary of Invention

The present invention aims at overcoming all or part of the drawbacks of the prior art, in particular those set out above.

To this end, and according to a first aspect, the present invention proposes a method for recovering the symbol time by a receiving device in order to decode a sequence of symbols transmitted by a transmitting device in a case where the symbol time of the transmitting device has a bias relative to the symbol time of the receiving device. The method comprises the following steps:
a sampling of a baseband signal representative of the sequence of symbols, each symbol being associated with a sampling “symbol instant”,
for a symbol, called “current symbol”, a detection of a transition between the current symbol and the symbol preceding the current symbol, said transition being detected if the current symbol and the preceding symbol have different states,
in the presence of a transition:
   a measurement of an absolute error on the symbol instant of the current symbol,
   an update, depending on the measured absolute error, of a statistical model of the bias between the symbol time of the transmitting device and the symbol time of the receiving device,
   a correction of the symbol instant of the subsequent symbol depending on the measured absolute error and/or depending on a bias estimated from the statistical model,
in the absence of a transition:
   an extrapolation of a relative error on the symbol instant of the current symbol from the statistical model,
   a correction of the symbol instant of the subsequent symbol depending on the extrapolated relative error.

The measured absolute error or the extrapolated relative error on the symbol instant of the current symbol is representative of a delay or an advance of the estimated symbol instant relative to the exact symbol instant of the current symbol.

The bias estimated from the statistical model is representative of a drift of the symbol time of the transmitting device relative to the symbol time of the receiving device. This drift causes an additional delay or advance to each new symbol. The estimated bias is therefore representative of a time error per symbol.

With such arrangements, during the periods when there are no transitions between symbols, even if an absolute error cannot be measured, it remains possible to apply a correction to the instants of the subsequent symbols depending on the estimated bias using the statistical model.

In particular implementations, the invention may further include one or more of the following features, taken in isolation or in all technically possible combinations.

In particular implementations, a correction of the symbol instant of the subsequent symbol is performed only if a predetermined criterion is verified during a verification step.

In particular implementations, the verification of the predetermined criterion includes a comparison of the value of the correction to be performed with a predetermined threshold.

Such arrangements allow avoiding inadvertent corrections due, for example, to temporal fluctuations of the symbol time which only impact certain symbols locally. In particular, this can prevent the error, after correction, from being worse than before the correction.

In particular implementations, the verification of the predetermined criterion includes a comparison of a number of elements contained in the statistical model with a predetermined threshold.

In particular implementations, the verification of the predetermined criterion includes a verification that the value of the correction to be performed falls within a confidence interval subject to a given statistical power.

Indeed, the greater the number of elements contained in the statistical model is, the greater the accuracy of the bias estimate will be. Such arrangements therefore allow avoiding applying a correction if the confidence granted to this correction is not sufficient (or in other words if the probability that the correction is actually relevant is not high enough).

In particular implementations, the baseband signal is obtained by the receiving device from a signal which is phase or frequency modulated by the sequence of symbols by the transmitting device.

In particular implementations, the signal is modulated by the transmitting device by a BPSK, DBPSK, GFSK or DGFSK modulation.

In particular implementations, the method includes a preliminary step, by the transmitting device, before the transmission of the sequence of symbols, of inserting a synchronization pattern at the beginning of the sequence of symbols, said synchronization pattern including a sequence of symbols known both by the transmitting device and by the receiving device.

In particular implementations, the sequence of symbols of the synchronization pattern has a ratio between a number of transitions between symbols and the number of symbols which compose the synchronization pattern which is at least equal to a predetermined threshold. For example, the number of transitions between symbols is at least equal to half the number of symbols which compose the synchronization pattern.

According to a second aspect, the present invention relates to a computer program product including a set of program code instructions which, when executed by a processor, configure said processor to implement a method for recovering the symbol time according to any one of the preceding implementations.

According to a third aspect, the present invention relates to a receiving device of a communication system including means configured to implement a method for recovering the symbol time according to any one of the preceding implementations.

According to a fourth aspect, the present invention relates to a communication system including such a receiving device.

### BRIEF DESCRIPTION OF FIGURES

The invention will be better understood on reading the following description, given by way of nonlimiting example, and made with reference to FIGS. 1 to 6 which represent:

FIG. 1 is a schematic representation of a wireless communication system,

FIG. 2 is a schematic representation of a signal representing a sequence of binary symbols to be transmitted by a transmitting device,

FIG. 3 is a schematic representation of a baseband signal representing a sequence of binary symbols established by a receiving device,

FIG. 4 is a schematic representation of the main steps of a method for recovering the symbol time according to the invention,

FIG. 5 is a schematic representation of an example of implementation of a measurement of an absolute error on the instant of a current symbol, and

FIG. 6 is a schematic representation of the main steps of a particular implementation of a method for recovering the symbol time according to the invention.

In these figures, identical references from one figure to another designate identical or similar elements. For reasons of clarity, the represented elements are not necessarily to the same scale, unless otherwise stated.

### DETAILED DESCRIPTION OF AN EMBODIMENT OF THE INVENTION

As previously indicated, the present invention finds a particularly advantageous application, although in no way limiting, in wireless communication systems of the IoT type. In the remainder of the description, we will consider the case of such a system as a nonlimiting example.

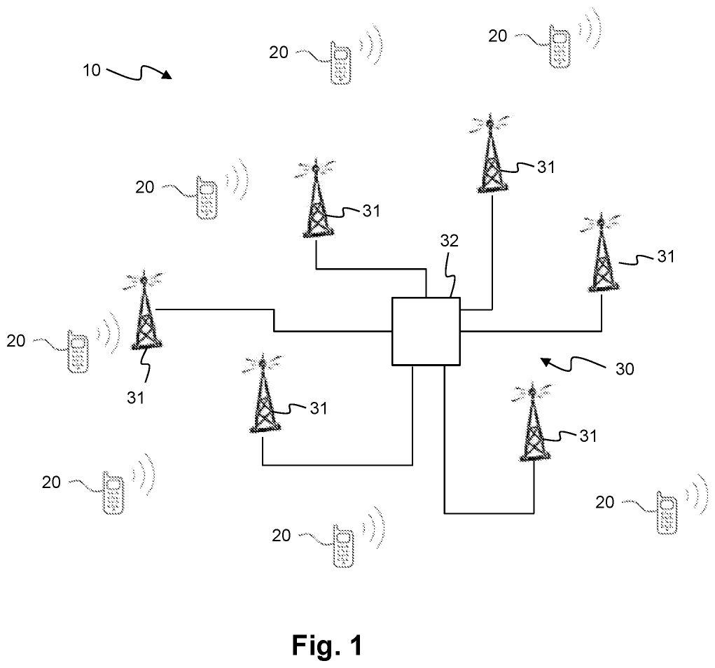

FIG. 1 schematically represents an IoT-type wireless communication system 10, including one or more terminals 20 and an access network 30. The access network 30 includes several base stations 31 and a server 32 connected to said base stations 31.

In such a wireless communication system 10, the data exchanges are essentially one-way, in this case on an uplink from the terminals 20 to the access network 30 of the wireless communication system 10. In the remainder of the description, by way of nonlimiting example, it is considered that the terminals 20 are transmitting devices 20. However, nothing prevents the terminals from also being able to act as a receiving device for receiving messages originating from the access network 30. When a terminal acts as a receiving device, it can also implement the method for recovering the symbol time according to the invention.

In order to minimize the risks of losing a message transmitted by a transmitting device 20, the planning of the access network is often carried out such that a given geographical area is covered simultaneously by several base stations 31, so that a message transmitted by a transmitting device 20 can be received by several base stations 31.

Each base station 31 is adapted to receive messages from the transmitting devices 20 which are within its range. Each message thus received is for example transmitted to the server 32 of the access network 10, possibly accompanied by other information such as an identifier of the base station 31 which received it, a value representative of the quality of the radio signal carrying the message, the central frequency on which the message was received, a date on which the message was received, etc. The server 32 processes, for example, all messages received from the different base stations 31. The communication link between a base station 31 and the server 32 can be supported by an optical fiber or an electric cable, but it can also be a radio communication link.

In the remainder of the description, it is considered by way of nonlimiting example that the base stations 31 are receiving devices 31 implementing a method for recovering the symbol time according to the invention. However, nothing prevents the base stations from also being able to act as a transmitting device to send messages to a terminal 20. In a variant, the decoding of a message can be carried out at the server 32 (and not at the base station 31). In such a case, it is the server 32 which acts as the receiving device implementing the method for recovering the symbol time according to the invention.

The communication system 10 is for example a wireless low power wide area network known by the term LPWAN. Such a wireless communication system is a long-range access network (greater than one kilometer, or even greater than a few tens of kilometers), with low energy consumption (for example an energy consumption during transmitting or receiving a message less than 100 mW, even less than 50 mW, or even less than 25 mW), and whose throughputs are generally less than 1 Mbits/s. Such wireless communication systems are particularly adapted for applications involving connected objects of the IoT type.

In particular implementations, the communication system 10 may be an ultra-narrow band communication system. The term “Ultra Narrow Band” (or UNB), means that the instantaneous frequency spectrum of the radio signals emitted by the transmitting devices 20 has a frequency width of less than two kilohertz, or even less than one kilohertz. Such a system allows significantly limiting the electrical consumption of the transmitting devices 20 when they communicate with the access network.

The transmitting device 20 is configured to transmit a message to a receiving device 31. For this purpose, the transmitting device 20 includes a processing circuit including a memory, one or more processors and a communication module. The communication module allows, in a conventional manner, implementing the different steps of a digital transmission chain (source coding, channel coding, modulation, frequency transposition, radio transmission, etc.). For this purpose, the communication module includes a set of hardware and/or software means, considered as known to those skilled in the art (encoder, local oscillator, mixer, filter, digital/analogue converter, amplifier, antenna, etc.).

In the remainder of the description, there is considered, by way of example and without limitation, the case where a message transmitted by a transmitting device 20 intended for a receiving device 31 is encoded by a sequence of binary symbols. The invention could however also be applied to a modulation using symbols being able to take a number of different values which is greater than two.

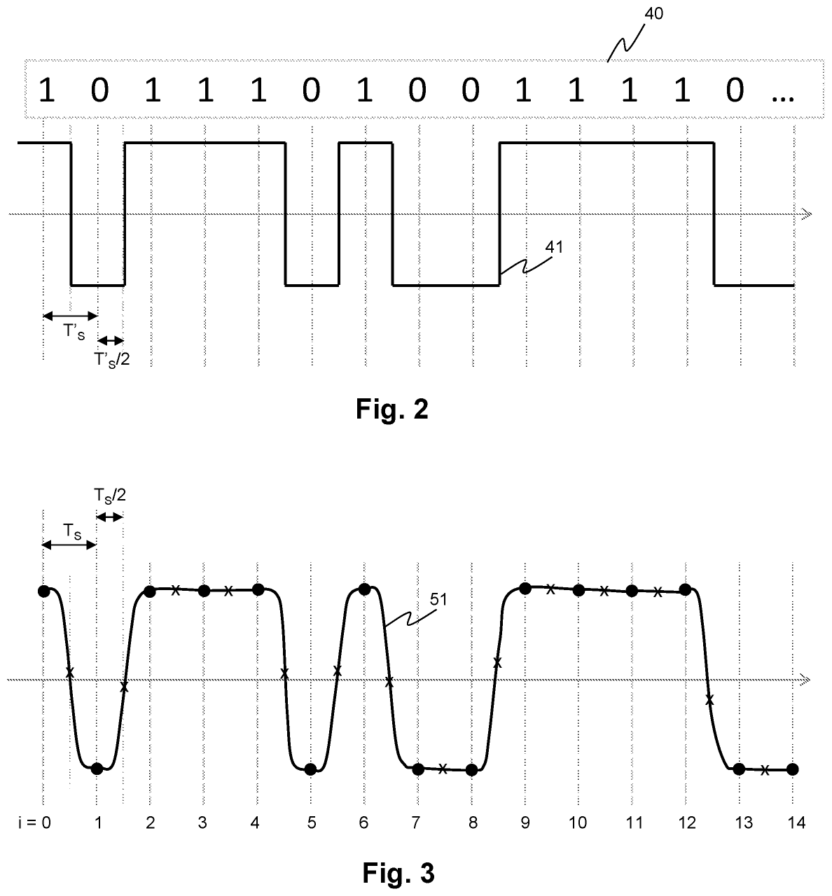

FIG. 2 schematically represents a sequence 40 of binary symbols encoding a message to be transmitted by a transmitting device 20 to a receiving device 31. Each binary symbol takes the value ‘1’ or the value ‘0’. Each symbol is transmitted with a symbol transmission frequency f′_{S}=1/T′_{S}. T′_{S} is the duration of transmission of a binary symbol.

A signal 41 representative of the sequence 40 of symbols to be transmitted is also illustrated in FIG. 2. The signal 41 takes a “high” state for each symbol with value ‘1’ and a “low” state for each symbol with value ‘0’. The signal 41 is for example used to modulate a carrier taking the form of a high frequency sinusoidal signal, such as for example a frequency of an ISM (acronym for “Industrial, Scientific and Medical”) band. In the considered example, the carrier has a frequency of 868 MHz and the symbols are transmitted at a throughput of 100 baud (100 symbols per second). The used modulation can be a phase modulation, a frequency modulation or an amplitude modulation. More particularly, a phase modulation of the BPSK (acronym for “Binary Phase Shift Keying”) type or of the DBPSK (acronym for “Differential Binary Phase Shift Keying”) type can be used. According to other examples, a frequency modulation of the GFSK (“Gaussian Frequency Shift Keying”) or DGFSK (“Differential Gaussian Frequency Shift Keying”) type can also be used. Such modulations are relatively simple to implement, which is particularly well adapted for low-cost transmitting devices of the IoT type. However, these modulations do not favor the transitions between symbols. It should be noted that other modulations could be used, and the choice of a particular modulation is only one variant of the invention.

The signal carrying the message transmitted by the transmitting device 20 then corresponds to the carrier modulated by the signal 41 representative of the sequence 40 of binary symbols encoding said message.

The receiving device 31 is configured to receive a message originating from a transmitting device 20. For this purpose, the receiving device 31 includes a processing circuit including a memory, one or more processors and a communication module.

The communication module allows, in a conventional manner, implementing the different steps of a digital reception chain (radio reception, frequency transposition, demodulation, channel decoding, source decoding, etc.). For this purpose, the communication module includes a set of hardware and/or software means, considered as known to those skilled in the art (antenna, amplifier, local oscillator, mixer, analogue/digital converter, filter, decoder, etc.).

A computer program stored in the memory of the receiving device includes a set of program code instructions which, when executed by the processor(s), configure the processor(s) to implement a method 100 for recovering the symbol time according to the invention.

Alternatively, or in addition, the receiving device 31 includes one or more programmable logic circuits (FPGA, PLD, etc.), and/or one or more specialized integrated circuits (ASIC), and/or a set of discrete electronic components, etc., adapted to implement all or part of the steps of the method 100 for recovering the symbol time according to the invention. In other words, the receiving device 31 includes means which are software (specific computer program product) and/or hardware (FPGA, PLD, ASIC, discrete electronic components, etc.) configured to implement the steps of the method 100 according to the invention.

FIG. 3 schematically represents a baseband signal 51 constructed in a conventional manner by the receiving device 31 from the modulated carrier transmitted by the transmitting device 20 to transmit the message encoded by the sequence 40 of binary symbols represented in FIG. 2. The baseband signal 51 is representative of the sequence 40 of binary symbols: it takes a “high” state when a symbol takes the value ‘1’ and a “low” state when a symbol takes the value ‘0’. Conventionally, the signal 51 is sampled by the receiving device 31, and each symbol is associated with a sampling “symbol instant”. In FIG. 3, the value of each sample corresponding to a symbol instant is represented by a point. The time difference between two symbol instants is denoted T_{S}.

The sampling frequency is at least equal to the symbol reception frequency f_{S}=1/T_{S}. The sampling frequency is generally a multiple of the symbol reception frequency f_{S}. In FIG. 3, each cross represents a sample obtained in the middle of the interval separating two symbol instants.

Each binary symbol is associated with an index i. In FIG. 2, the samples of index i=0, 2, 3, 4, 6, 9, 10, 11 and 12 correspond to symbols of value ‘1’ because the signal 51 takes, in these samples, a “high” state corresponding to a sample value which is greater than a predetermined high threshold. The samples of index i=1, 5, 7, 8, 13 and 14 correspond to symbols of value ‘0’ because the signal 51 takes, in these samples, a “low” state corresponding to a sample value which is less than a predetermined low threshold.

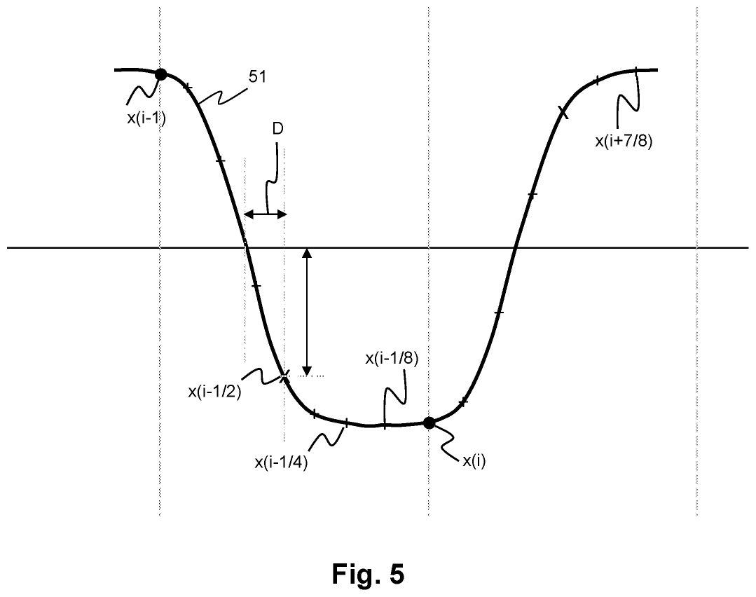

As illustrated in FIG. 5, the value of a sample corresponding to a symbol of index i is denoted x(i). The value of a sample of the signal 51 located in the middle of the interval between two samples of index (i−1) and i is denoted x(i−1/2). In the example considered and illustrated in FIG. 5, the sampling frequency is eight times greater than the symbol reception frequency f_{S}, the samples x(i−7/8), x(i−3/4), x(i−5/8), x(i−1/2), x(i−3/8), x(i−1/4) and x(i−1/8) are then found between the sample of index (i−1) and the sample of index i.

In order to maintain a perfect synchronization of the symbols, the frequency f′_{S} for transmitting the symbols by the transmitting device and the frequency f_{S} for receiving the symbols by the receiving device must be identical. However, a drift may exist between the clock used by the transmitting device for the transmission of symbols and the clock used by the receiving device for the reception of the symbols. In other words, a bias may exist between the symbol time of the transmitting device and the symbol time of the receiving device (the values T′_{S} and T_{S} not being exactly identical). This bias can be particularly significant for low-cost transmitting devices whose clocks are not always very reliable.

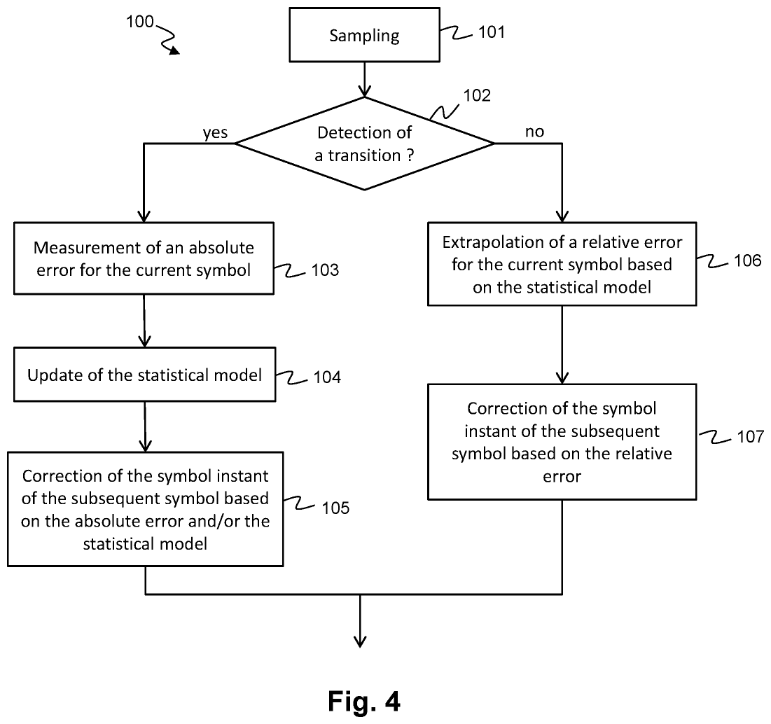

FIG. 4 represent the main steps of a method 100 for recovering the symbol time implemented by the receiving device 31 to efficiently decoding the sequence 40 of binary symbols transmitted by the transmitting device 20 even if a non-negligible bias exists between the symbol time of the transmitting device and the symbol time of the receiving device.

A first step corresponds to the sampling 101 of the baseband signal 51. This step has already been previously described with reference to FIGS. 2 and 5.

A second step corresponds, for a current symbol of index i, to the detection 102 of a transition between this current symbol and the preceding symbol of index (i−1). A transition is detected if the current symbol of index i and the preceding symbol of index (i−1) have different states. In the example illustrated in FIG. 2, the symbols of index i=1, 2, 5, 6, 7, 9 and 13 correspond to symbols for which a transition is detected relative to the preceding symbol. However, for the symbols of index i=3, 4, 8, 10, 11, 12 and 14, no transition is detected relative to the preceding symbol. Different methods can be used to detect a transition between a current symbol of index i and the preceding symbol of index (i−1). For example, a transition is detected if the absolute value of the difference between the samples x(i) and x(i−1) is greater than a predetermined threshold.

If a transition is detected, the method 100 for recovering the symbol time comprises the following steps:
a measurement 103 of an absolute error on the symbol instant of the current symbol of index i,
an update 104, depending on the measured absolute error, of an estimated mean bias between the symbol time of the transmitting device and the symbol time of the receiving device,
a correction 105 of the symbol instant of the subsequent symbol of index (i+1) depending on the measured absolute error and/or depending on the estimated mean bias.
   It should be noted that the order of steps 104 and 105 is not necessarily fixed. Thus, the correction 105 of the symbol instant of the subsequent symbol can possibly be performed depending on the previously estimated mean bias, before the mean bias is updated.

If a transition is not detected, the method 100 for recovering the symbol time includes the following steps:
an extrapolation 106 of a relative error on the symbol instant of the current symbol of index i from the estimated mean bias,
a correction 107 of the symbol instant of the subsequent symbol of index (i+1) depending on the extrapolated relative error.

The estimated mean bias is stored by the receiving device 31. The estimated mean bias is for example updated each time a transition is detected between two consecutive symbols. When there is no transition between two consecutive symbols, the estimated mean bias is not updated, but it can nevertheless be used to correct the symbol time. The method 100 according to the invention thus allows correcting the symbol time even in the absence of transitions between symbols. This is particularly advantageous in the case where many identical symbols succeed each other without transition, because this allows maintaining the symbol synchronization even if it is not possible to measure an absolute error for a current symbol.

FIG. 5 schematically represents an example of implementation of the step 103 of measuring an absolute error on the symbol instant of a current symbol of index i. The absolute error is denoted E_{abs} and it is calculated for example in the form of Equation 1:

E_{abs}=K×[x(i)−x(i−1)]×x(i−1/2)

The sign of the value of the term [x(i)−x(i−1)] indicates whether the transition corresponds to the passage from a high state to a low state (the value of this term is then negative) or to the passage from a low state to a high state (the value of this term is then positive).

When a transition corresponds to the passage from a high state to a low state, the term x(i−1/2) is negative when the estimated symbol instant of the current symbol is in delay relative to the exact instant of the symbol, and it is positive when the estimated symbol instant of the current symbol is in advance relative to the exact instant of the symbol. Conversely, when a transition corresponds to the passage from a low state to a high state, the term x(i−1/2) is positive when the estimated symbol instant of the current symbol is in delay compared to the exact instant of the symbol, and it is negative when the estimated symbol instant of the current symbol is in advance relative to the exact instant of the symbol.

Thus, the sign of the absolute error E_{abs} indicates whether the measured error corresponds to a delay (the absolute error E_{abs} is then positive) or to an advance (the absolute error E_{abs} is then negative) relative to the exact symbol instant of the current symbol.

The absolute value of the term x(i−1/2) is particularly representative of the importance of the error (corresponding to a delay or an advance) on the symbol instant of the current symbol. The greater this value, the greater the delay or advance relative to the exact instant of the symbol.

K is a positive constant which allows obtaining an absolute error E_{abs} in the time domain from the amplitude measurements which are performed for the current symbol.

In the example illustrated in FIG. 5, the measured absolute error E_{abs} is representative of the delay D of the estimated symbol instant for the symbol of index i (instant corresponding to the sampling instant of the value x(i)) relative to the exact symbol instant of the symbol of index i. In the absence of delay (and advance), the sample x(i−1/2) located in the middle of the time interval separating the sample x(i−1) and the sample x(i) would take a zero value.

Other methods could be used to measure the absolute error E_{abs} on the symbol instant of a current symbol. The choice of a particular method for measuring this absolute error is only one variant of the invention.

The value of the estimated mean bias is for example denoted β. The mean bias β is for example initialized to zero, and when a transition is detected for a current symbol of index i>0, the step 104 of updating the mean bias β is for example performed as follows, Equation 2:

$$β = \frac{β \times ( i - 1 ) + {E}_{abs}}{i}$$

The estimated mean bias β then corresponds to a delay (if β>0) or to an advance (if β<0) to be corrected for each new considered current symbol. Other calculation methods can be used to estimate the mean bias β (for example by a linear regression or other statistical models, possibly with a deletion of certain measurements which would have excessive variations). The choice of a particular method for estimating the mean bias β is only one variant of the invention.

A correction 105 can then be applied to the symbol time. The value of the correction to be applied can be calculated depending on the measured absolute error E_{abs} and/or depending on the estimated mean bias β.

Consider for example a scenario where the sampling frequency f_{E} is N times greater than the symbol reception frequency f_{S} (f_{E}=N×f_{S}). The correction 105 may consist in shifting the symbol instants of the subsequent symbols by a duration corresponding to a fraction of the duration T_{S}. For example, the sample corresponding to the subsequent symbol of index (i+1) would become the sample, Equation 3:

$$x ( i + 1 - \frac{⌊ \frac{β \times N}{{T}_{S}} ⌋}{N} )$$

where └A┘ is the integer portion of A. In this formula, the used mean bias β can be the mean bias which is estimated before or after the update performed from the measured absolute error E_{abs}.

According to another example, where the correction 105 is calculated directly from the measured absolute error, the sample corresponding to the subsequent symbol of index (i+1) would become the sample, Equation 4:

$$x ( i + 1 - \frac{⌊ \frac{{E}_{abs} \times N}{{T}_{S}} ⌋}{N} )$$

In the example illustrated in FIG. 5, the value of N is eight (N=8), and the correction 105 could consist in advancing the subsequent symbol instants by a duration corresponding to T_{S}/8. The symbol instant of the subsequent symbol of index (i+1) would thus be modified to become the instant of the sample x(i+7/8).

When there is no transition between a preceding symbol of index (i−1) and a current symbol of index i, it is not possible to measure an absolute error on the estimated instant of the current symbol. However, a relative error on the estimated instant of the current symbol can be extrapolated (in step 106) from the estimated mean bias β. This thus allows correcting (in step 107) the symbol instant of the subsequent symbol of index (i+1) depending on the extrapolated relative error. For example, the extrapolated relative error is equal to the estimated mean bias β, and the applied correction is similar to that presented in the formula [Math. 3] above.

It should be noted, however, that a correction is not necessarily applied to each new current symbol. For example, the correction is applied only if a predetermined criterion is verified. In this case, an accumulated error E_{acc} should be maintained. The accumulated error E_{acc} is updated with each new current symbol, and it is reset each time a symbol time correction is performed.

Applying a correction only if a particular criterion is verified allows, on the one hand, limiting the number of corrections to be performed and, on the other hand, avoiding inadvertent corrections due, for example, to temporal fluctuations of the symbol time (jitter) which only impact certain symbols locally. The bias is estimated according to a statistical model and the weight of a measurement decreases when the set of the measurements grows. The application of a criterion can be linked to the resolution of the correction, which can be set by the value of the oversampling. The use of a particular criterion can in particular allow preventing the error after correction from being worse than before the correction.

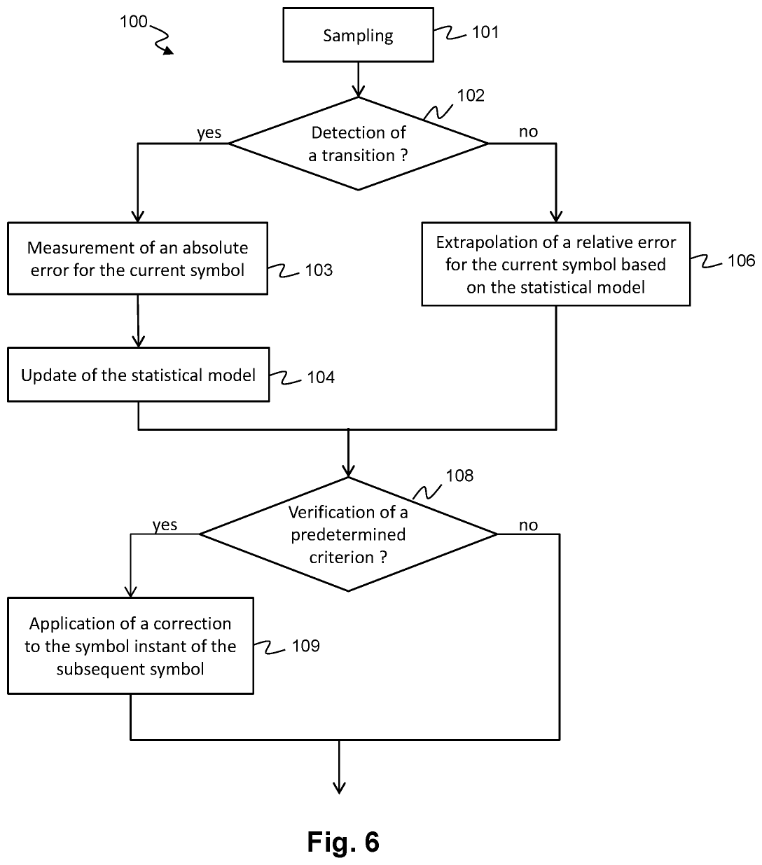

FIG. 6 schematically represents the steps of a particular implementation of the method 100 for recovering the symbol time in which a correction 109 is only applied if a particular criterion is verified during a verification step 108.

Steps 101 to 106 correspond to steps 101 to 106 which are previously described with reference to FIG. 4.

The correction 109 of the instant of the subsequent symbol of index (i+1) corresponds either to the correction 105 described with reference to FIG. 4 in the case where a transition has been detected for the current symbol of index i, or to the correction 107 described with reference to FIG. 4 in the case where a transition has not been detected for the current symbol of index i. However, the correction 109 only takes place if a particular criterion is verified during the verification step 108.

According to a first example, an accumulated error E_{acc} is calculated for each current symbol, and a correction 109 of the symbol instant of the subsequent symbol is performed only if the accumulated error E_{acc} is greater than a predetermined threshold, the accumulated error being reset to zero when a correction is made. According to another example, the correction 109 is only performed if the number of symbols elapsed since the last time a correction was performed is greater than a certain threshold.

For the implementation described with reference to FIG. 6, the estimated mean bias β is for example updated in step 104 according to the following formula, Equation 5, when a transition is detected for a current symbol (the mean bias is not updated if a transition is not detected):

$$β = \frac{β \times ( i - 1 ) + ( {E}_{abs} - {E}_{acc} )}{i}$$

The absolute error E_{abs} corresponds to the temporal error measured for the instant of a current symbol. The absolute error E_{abs} comprises in particular the sum of the errors which are accumulated and not corrected during the preceding symbols.

The accumulated error E_{acc} initially takes the value zero. When a current symbol of index i is processed, the accumulated error E_{acc} is for example updated according to the following formula, Equation 6:

E_{acc}=E_{acc}+β

According to another example, if a measurement of the absolute error E_{abs} is performed on the current symbol, it is also possible to assign the value of the absolute error E_{abs} to the accumulated error E_{acc} (E_{acc}=E_{abs}).

If the criterion is verified in step 108, then a correction 109 is applied for example in a manner similar to what has been described with reference to the formula [Math. 3] above, and the accumulated error is reset (E_{acc}=0).

According to another example, rather than resetting the accumulated error E_{acc} to the value zero, it is possible to subtract, from the accumulated error E_{acc}, the value of the applied correction.

The above description was made by considering the calculation of a mean bias between the symbol time of the transmitting device and the symbol time of the receiving device. The calculation of a mean value of the bias allows simplifying the implementation since it is then not necessary to memorize the values of the errors which are measured successively for each current symbol having a transition relative to the preceding symbol. Indeed, in order to calculate a mean value of the bias, it is sufficient to store an accumulated error. However, the accuracy of the bias estimate is sometimes not sufficient when the bias is estimated from a mean value. As previously mentioned, the bias can be estimated using a statistical model. The use of a statistical model necessarily implies collecting and storing a large number of values corresponding to the errors measured successively for the symbols having a transition. In return, the accuracy of the bias estimation is greatly improved.

The statistical model may in particular be a linear regression. However, other statistical models can be considered (nonlinear regression, machine learning algorithms, etc.).

If reference is made again to FIG. 4, when a statistical model is used, the update step 104 corresponds to a supply of the statistical model with the absolute error measured on the current symbol instant. The step 105 of correcting the symbol instant of the subsequent symbol can then be performed depending on the measured absolute error and/or depending on an estimated bias β from the statistical model. The statistical model can in particular provide information on an estimated absolute value of the bias at a current instant (estimated absolute error between the estimated symbol instant and the exact symbol instant of the current symbol) and/or on an estimated value of a bias per time symbol (relative error introduced with each new symbol). In the absence of transition, the step 106 of extrapolating the relative error on the symbol instant of the current symbol is performed using the statistical model.

It should be noted that the evolution of the existing bias between the symbol time of the transmitting device and the symbol time of the receiving device can vary over time. The statistical model can advantageously allow modeling this evolution and accurately estimating a future bias value, even during periods when there is no transition between symbols and when it is therefore not possible to make a measurement on the error of the current symbol instant.

Again, a correction is not necessarily applied to each new current symbol. Indeed, it is possible to perform a correction of the symbol instant only if a predetermined criterion is verified.

If reference is made to FIG. 6, in the case where a statistical model is used, the step 108 of verifying the predetermined criterion may in particular include a comparison of the value of the correction to be made with a predetermined threshold. Such arrangements allow avoiding inadvertent corrections due for example to significant temporal fluctuations of the symbol time which only impact certain symbols locally. In particular, this can prevent the error after correction from being worse than before the correction.

The step 108 of verifying the predetermined criterion can also include a comparison of the number of elements contained in the statistical model with a predetermined threshold. The number of elements contained in the statistical model corresponds to the number of measurements 103 of an absolute error performed over time on the symbols for which a transition has been detected. Each absolute error thus measured is indeed stored and used to update the statistical model (step 104). The greater the number of elements contained in the statistical model is, the greater the accuracy of the bias estimate will be. Such arrangements therefore allow avoiding applying a correction if the confidence granted to this correction is not sufficient (or in other words if the probability that the correction is actually relevant is not high enough).

According to yet another example, the verification of the predetermined criterion includes a verification that the value of the correction to be performed falls within a confidence interval subject to a given statistical power. The statistical power of a test is the probability of wisely rejecting (because it is false) a hypothesis which is considered true a priori (the null hypothesis). The statistical power is the value (1−b), where b is the probability of not rejecting the null hypothesis when it is false (b is the “second kind risk”). The statistical power is generally defined depending on the number of elements in the statistical model, the spread of the elements, and the threshold of the test (critical probability or “p-value”). The confidence interval provides a range of likely values. The confidence interval is generally also defined depending on the number of elements in the statistical model, their dispersion, and the threshold of the test. The test threshold sets the confidence level of the interval. The confidence of a test is the probability of not rejecting the null hypothesis when it is true. The confidence is the value (1−a), where a is the probability of rejecting the null hypothesis when it is true (a is the “first kind risk”).

As previously indicated, the use of a statistical model can also allow filtering out certain measurements which would have too large variations in the model. This allows optimizing the accuracy of the bias estimate from the statistical model. Statistically, the accuracy of the bias estimate is improved over time. Advantageously, it is possible to insert, at the beginning of each message, a synchronization pattern including a sequence of symbols known both by the transmitting device and by the receiving device in order to optimize the convergence of the estimated bias towards the real value of the bias existing between the symbol time of the transmitting device and the symbol time of the receiving device. Preferably, the synchronization pattern is selected so that the symbols which compose it have a large number of state transitions, for example a number of transitions which is at least equal to half the number of symbols which compose the synchronization pattern.

The above description clearly illustrates that, through its different features and their advantages, the present invention achieves the set objectives. In particular, the invention allows correcting the symbol time of a receiving device even during periods of time when there are no transitions between the symbols. Such arrangements allow maintaining a symbol synchronization between a transmitting device and a receiving device even if a significant bias exists between the symbol time of the transmitting device and the symbol time of the receiving device.

Measurements were carried out to demonstrate the effectiveness of the method according to the invention. For a theoretical frequency of symbols of 100 bauds (100 symbols per second), and with a signal on noise ratio (SNR) of 20 dB, a receiving device which implements the method according to the invention is capable of decoding a message with a success rate close to 100% if the actual transmission frequency of the symbols of the transmitting device is comprised between 92 and 108 bauds (i.e. an error of +/−8% on the theoretical symbol frequency). However, a receiving device which does not implement the method according to the invention is only capable of decoding a message with a success rate close to 100% if the actual transmission frequency of the symbols of the transmitting device is comprised between 99.5 and 100.5 bauds (i.e. an error of +/−0.5% on the theoretical symbol frequency).

More generally, it should be noted that the implementations and embodiments considered above have been described by way of nonlimiting examples, and that other variants are therefore possible. In particular, the choice of a particular method for detecting a transition between two consecutive symbols, for measuring an error at the instant of a current symbol having a transition relative to the preceding symbol, and/or for estimating a bias from several measurements performed on symbols with transition, corresponds only to a variant of the invention.

The invention has been described for binary modulations. However, nothing prevents the invention from being applied to modulations for which the symbols can take a number of discrete values which is greater than two. Using a modulation with symbols having more than two states will potentially impact the method for detecting a state transition between two symbols, as well as the method for measuring an absolute error on a symbol instant, but the core of the invention consisting in modeling a bias to apply a correction to the symbol time during a period when there is no transition between symbols remains applicable.

The invention has been described by considering an IoT-type wireless communication system 10. However, nothing excludes considering other digital communication systems, including wired communication systems.

1-12. (canceled)

13. A method for symbol time recovery, the method being implemented by a receiver to decode a sequence of symbols received from a transmitter, a symbol time of the transmitter having a bias relative to a symbol time of the receiver, the method comprising:
sampling a baseband signal representative of the sequence of symbols, each symbol of the sequence of symbols being associated with a symbol instant,
detecting a transition between a current symbol and a preceding symbol which immediately precedes the current symbol in the sequence of symbols, the transition being detected if the current symbol and the preceding symbol have different states,
in a presence of the transition:
measuring an absolute error on the symbol instant of the current symbol,
depending on a measured absolute error, updating a statistical model of the bias between the symbol time of the transmitter and the symbol time of the receiver, and
correcting the symbol instant of a subsequent symbol which immediately follows the current symbol in the sequence of symbols depending on at least one of the measured absolute error and the bias estimated from the statistical model, and
in an absence of a transition:
extrapolating a relative error on the symbol instant of the current symbol from the statistical model, and
correcting the symbol instant of the subsequent symbol depending on an extrapolated relative error.

14. The method of claim 13, wherein the statistical model is a linear regression.

15. The method of claim 1, wherein the symbol instant of the subsequent symbol is corrected only if a verification of a predetermined criterion is satisfied.

16. The method of claim 15, wherein the verification of the predetermined criterion comprises a comparison of a correction value to a predetermined threshold.

17. The method of claim 15, wherein the verification of the predetermined criterion comprises a verification that a correction value falls within a confidence interval subject to a given statistical power.

18. The method of claim 17, wherein the baseband signal is obtained by the receiver from a signal which is phase or frequency modulated by the sequence of symbols by the transmitter.

19. The method of claim 18, wherein the signal is modulated by the transmitter by one of the following modulation: a binary phase shift keying (BPSK), a differential binary phase shift keying (DBPSK), a Gaussian frequency shift keying (GFSK) and a differential Gaussian frequency shift keying (DGFSK).

20. The method of claim 13, further comprising a preliminary step, by the transmitter, before a transmission of the sequence of symbols, of inserting a synchronization pattern at a beginning of the sequence of symbols, the synchronization pattern comprising a sequence of symbols known both by the transmitter and the receiver.

21. The method of claim 20, wherein the sequence of symbols of the synchronization pattern is chosen such that a ratio between a number of transitions between symbols and a number of symbols which compose the synchronization pattern is at least equal to a predetermined threshold.

22. A computer-readable storage medium comprising a set of program code instructions executable by a processor of the receiver to implement the method of claim 13 for recovering the symbol time of the receiver.

23. A receiver of a communication system comprising a processor configured to implement the method of claim 13 for recovering the symbol time of the receiver.

24. A communication system comprising the receiver of claim 23.
